(19) United States
(12) Patent Application Publication
(10) Pub. No.: US 2004/0078984 A1
(43) Pub. Date: Apr. 29, 2004

(54) Vehicle window removal knife

(76) Inventor: Mike Glodowski, Meridian, ID (US)

Correspondence Address: PEDERSEN & COMPANY, PLLC, P.O. BOX 2666, BOISE, ID, 83701, US

(21) Appl. No.: 10/279,774

(22) Filed: Oct. 23, 2002

(51) Int. Cl. B26B 3/00

(52) U.S. Cl. 30/298; 30/317; 30/312; 30/313

(57) ABSTRACT

An improvement to the standard manually powered cold knife used to remove vehicle windows is disclosed. The standard cold knife has a main handle, which is generally cylindrical. A blade is fixedly attached to the base of the handle, and is shaped to reach beneath vehicle window glass. A pull handle is attached at or near the base of the main handle of the standard cold knife. The invention is an additional stiff pull handle attached at or near the top of the main handle. The length of the additional pull handle is designed to roughly match that of the first pull handle, and the grip is designed so that the grip on the first pull handle roughly fits into it, allowing them to be comfortably gripped together.

### BACKGROUND OF THE INVENTION

1. Field of the Invention

This invention relates to knives, and more particularly to knives for removing vehicle windows.

2. Related Art

It is often necessary to remove a vehicle's window from its frame in order to replace or repair the window. The current method of installing a vehicle window in its frame is to bond it to the frame with a polymer adhesive such as polyurethane. Therefore, whenever it is necessary to remove a window, it is necessary to cut through the adhesive in order to release the window.

In the vehicle window replacement industry, there are standard knives for cutting through the window adhesive. The standard manual knife has a generally cylindrical handle with an essentially planar, pointed blade, which is bent at about 90°. The bend is roughly perpendicular to the centerline of the handle and to the plane of the base of the blade, which is the end of the blade attached to the handle. The blade has a short cable attached with a handle pivotally connected to the bottom portion of the knife in order to assist the repairman in pulling the blade through the strong adhesive.

The knife is used by inserting its sharp, pointed end through the adhesive, and then pulling it with both hands towards the repairman. However, during use, this knife tends to twist and rotate in the repairman's hands, causing an erratic cut and difficulties for the repairmen. Also, it is necessary, when using the handle attached by cord, that the force applied to the vertical, cylindrical handle be such that the blade is maintained at the proper pitch when the cord is pulled towards the repairman. This requires the repairman to resist the force applied through the cord in order to keep the blade parallel to the window, while also allowing the cylindrical handle to move towards the repairman while the adhesive is cut. After repeated use, the effect of these difficulties in controlling the knife are soreness, fatigue, and possible injury to the repairman's hands, wrist, and forearm.

Efforts have been made to remedy this problem. C. R. Laurence Co. markets a knife called the Euro-Knife, which purports to be ergonomical and reduces fatigue and strain. It also has a cylindrical handle with a bent, planar blade, and a handle attached by a cord. However, the cylindrical handle is attached so that it is generally parallel to the window during use rather than perpendicular. This changes the twist of the arm relative to the shoulders, but does not alleviate the tendency of the knife to twist or remove the need to resist the pull on the second handle with calibrated, changing force to the cylindrical handle. Therefore, fatigue and soreness are far from eliminated.

Glodowski (U.S. Pat. No. 5,400,510), issued Mar. 28, 1995, provides a handle that attaches to the top of the cylindrical handle of a standard cold knife at one end and to the user's forearm at the other end. This allows a more controlled cut with less strain on and fatigue to the user's arms. However, difficulties in controlling the pitch of the blade remain.

Also, the existing blades can only cut in one direction; they must be pulled toward the user. This can make it difficult to cut harder to reach sections of adhesive, such as sections in the middle of a wide and/or tall vehicle. A knife that could be pushed would decrease this problem by allowing the user to insert the blade through the adhesive at a convenient location rather than as far out over the vehicle as possible.

Therefore, there is a need to eliminate the tendency of a vehicle window removal knife to rotate and twist, causing an erratic cut, and to provide more force to the cutting blade over a longer distance, in the current manual knives for vehicle window removal.

### SUMMARY OF THE INVENTION

An addition to the standard manually powered “cold knife” used to remove vehicle windows is disclosed. The standard cold knife has a main handle, which is generally cylindrical. A blade is fixedly attached to the base of the handle, and is shaped to reach beneath vehicle window glass. A pull handle is attached directly or indirectly to the handle, preferably at or near the base of the main handle to assist in the use of the standard cold knife. The invention is an additional stiff pull handle attached directly or indirectly at or near the top of the main handle. The length of the additional pull handle is designed to roughly match that of the first pull handle, and the grip is designed so that the grip on the first pull handle roughly fits into it, allowing them to be comfortably gripped and pulled together.

### BRIEF DESCRTPTION OF THE DRAWINGS

FIG. 1 is an exploded perspective view of the preferred embodiment of the invention.

FIG. 2a is a front view of the preferred embodiment of the invention with the blade pointed toward the viewer and with the T-handle and Y-handle rotated to the left side, and demonstrating the T-handle's and Y-handle's plane of rotation.

FIG. 2b is a perspective view of the mating of the T-handle and Y-handle with an alternative preferred embodiment of the Y-handle.

FIG. 3 is a side view of the preferred embodiment of the invention's blade in use cutting the adhesive under a vehicle window.

FIG. 4 is a side view of the preferred embodiment of the invention's blade holding mechanism.

FIG. 5 is a perspective view of the preferred embodiment of the invention in use.

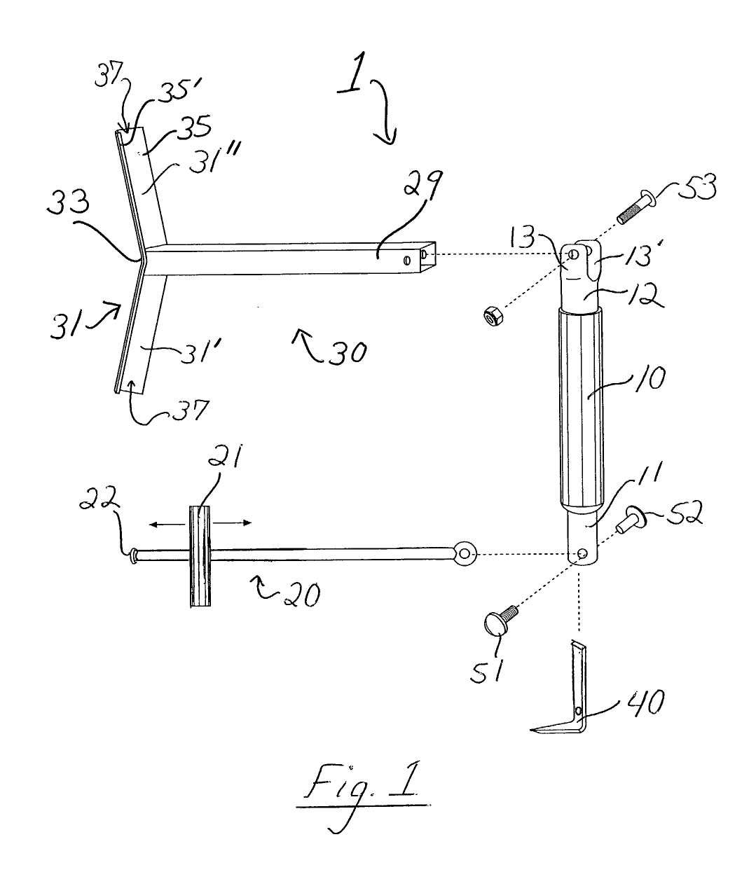

### DETAILED DESCRIPTION OF THE INVENTION

The invention is a modified knife for use in removing windows from vehicles. The preferred embodiment of the knife device 1 has four main parts: cold knife handle 10, T-handle 20, Y-handle 30, and blade 40. The cold knife handle 10 is formed from a tube. A stiff extension, called the stabilizer 11, is formed from two parallel slats 11′ and 11″ spaced far enough apart to allow the base 14 of a cold knife blade to fit between them, and is inserted into the tube and firmly attached to the tube. One slat 11′ is longer than the other and extends beyond the bottom of the main grip handle 10. The base 14 of the blade is slid into the empty space of the stabilizer and firmly bolted to the slat 11′ extending out the bottom of the handle 10 with a screw 51 and post bolt 52. The opposite end of the cold knife handle 10 also has an extension 12 with two parallel upright members 13 and 13′ through which a bolt 53 may pass.

The T-handle 20 is an elongated piece with two sections, which attaches to the cold knife handle 10 on the stabilizer 11 in a manner that allows the T-handle 20 to pivot about its connection to the stabilizer 11. It may be made from stiff or flexible material, but a stiff rigid material is preferred. The connection to the stabilizer 11 allows said T-handle 20 to rotate freely to either side of the cold knife handle 10. The section [22] of the T-handle 20 shaft furthest from the stabilizer 11 passes through a cylindrical hand grip 21. The hand grip 21 is slidable on the shaft of the T-handle 20, and the tip 22 of the T-handle 20 is widened so that the hand grip 21 cannot slide off the shaft of the T-handle 20.

The bottom portion 29 of the “Y” shape of the Y-handle 30 connects to the cold knife handle 10 between the top members 13 and 13′ of the cold knife handle by bolt 53, and pivots about said bolt 53. The Y-handle 30 should be made from a stiff rigid material, as this rigidity is important for preventing twisting of the knife device 1 during use. From the Figures and this Description, it is apparent that the preferred handle serves as a rigid member that extends from generally the top region of the handle, rearward to near the hand grip of the lower handle (T-handle 20), and that temporarily engages the lower handle. Preferably, handle 30 is pivotally connected to the handle so that it pivots in the plane of the tool, but not so that it can pivot, bend, or twist out of that plane. Therefore, this handle system provides a rigid “frame” for the knife device 1 on at least three sides of the device. The temporary connection between the handle 30 and the hand grip most preferably temporarily captures the handle along all or substantially all of the hand grip's length, which also helps prevent any twisting of the top handle (Y-handle 30) relative to the bottom handle (T-handle 20). By preventing twisting of the various parts of the device 1 relative to each other, the invented system also helps prevent twisting of the knife blade relative to the window (W) and the adhesive (A).

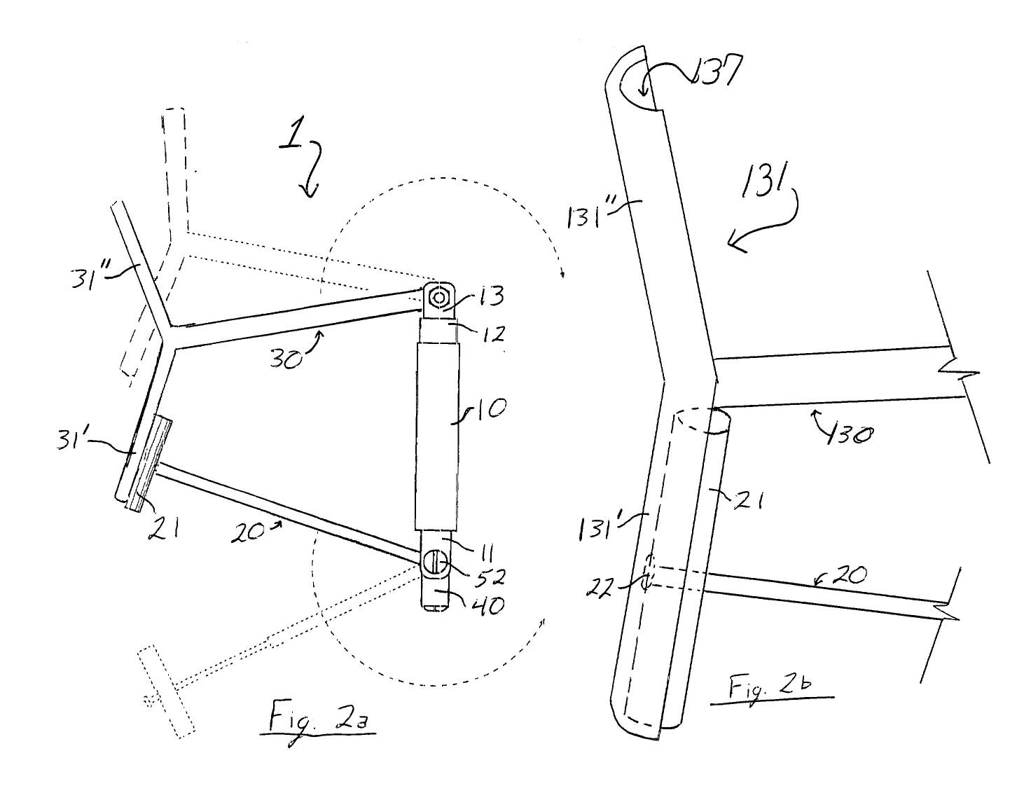

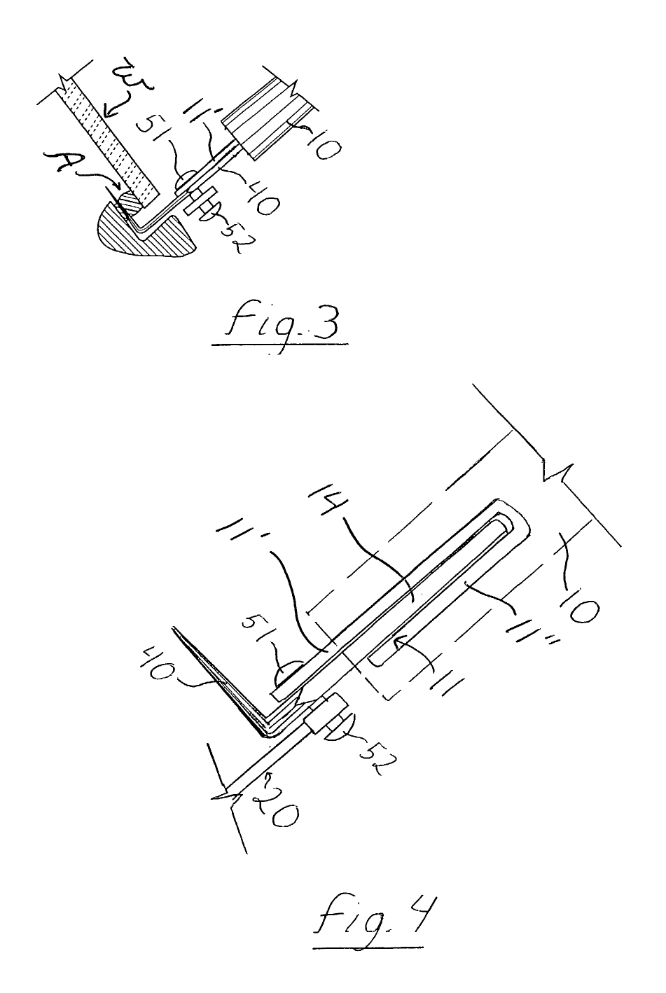

The “top portion” 31 of the “Y” is made from an inverted “V” formed from first and second sides 35, 35′ and resulting in an interior space 37 facing the handle 10. Top portion 31 angles away from the handle 10 at bend 33 to form a first end 31′ and a second end 31″. The angle created at bend 33 and the angle of the “V” result in a “cradle” parallel to the longitudinal axis of the hand grip 21, so that the hand grip 21 of the T-handle 20 fits into the “V” shaped interior space 37. Thus, the hand grip 21 is received in said first end 31′, for the T-handle and Y-handle position shown in FIG. 2a, and the T-handle 20 and Y-handle 30 can be held with the same hand. The hand grip 21 is preferably received, but not anchored or fastened, in the first end 31′ (or second end 31″) except by the user's hand. In this way, the user provides the temporary connection of the T-handle and the Y-handle with his/her hand, and, as soon as released, the two handles may be easily separated and moved to another desired position.

Alternatively, the top handle and/or the bottom handle of the device may be differently designed to allow connection of the two handles in various ways. For example, the Y-handle may be slightly shorter than the T-handle and may have an inverted V-shape, so that the concave or angular hand-grip-receiving-space of the Y-handle faces away from the main handle and receives the hand grip from the outer direction. This could still provide a cradling or connection of the two handles.

Furthermore, the lengths of the T-handle 20 and Y-handle 30 are roughly the same in order to create an optimal angle for pulling or pushing the knife, creating, in effect, a generally triangularly-shaped device that may be pulled or pushed from the point of the triangle opposite from the blade. Additionally, the Y-handle 30 can also be positioned with the Y-handle 30 swung up in FIG. 2a, to place the bottom portion 29 of the Y-handle 30 generally parallel to the cold knife handle 10, allowing the invention to be used more as a traditional cold knife, wherein one of the user's hand's grasps the bottom portion 29 and/or the handle 10, and the other hand grasps the T-handle 20.

Alternative means for connecting the top handle (Y-handle 30) and/or the bottom handle (T-handle 20) may be employed. For example, Y-handle 30 may be connected in an indirect manner, rather than the direct attachment shown in the drawings. By indirect connection, it is meant that the handle or handles may be preferably pivotally attached to another member, which another member is bolted or otherwise fastened to the handle. An elongated bar, plate, or sleeve, for example, may hold the handle(s) and may be bolted or otherwise fastened to the side surface of the handle 10′. Such indirect connection may be desirable for retrofitting the invented handle system to a commercially-available cold knife. Therefore, when “connection” is used in the claims, without the word “directly” or “indirectly,” it means either direct attachment or indirect connection.

As indicated in FIG. 2a, the preferred T-handle 20 and Y-handle 30 may pivot in the plane of the knife device 1, which is the plane of the paper of FIG. 2a. Preferably, the T-handle 20 and the Y-handle 30 can each pivot about 200-240 degrees, for example, from their positions mated together at the left of the handle 10 in FIG. 2a to a mirror-image position on the right of the handle 10 in FIG. 2a. In this position on the right of the handle 10, second end 31″ would receive and preferably cradle the hand grip 21.

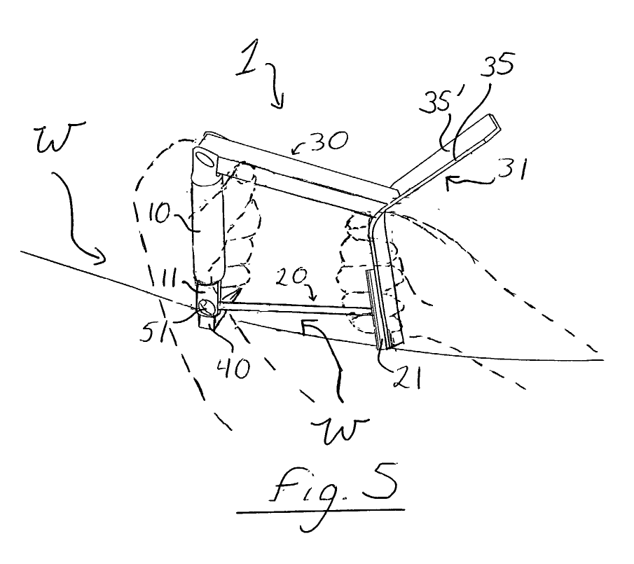

This pivoting system allows for pulling or pushing the knife device 1 from either side of the knife blade 40, depending on the user's preference or the particular window (W) shape and configuration and/or characteristics of the adhesive (A). For example, the knife device 1, shown in use in FIG. 5, could be pulled or pushed from the position shown in the figures. Alternatively, the device 1 in FIG. 5 could be removed from the window (W), the handles (20, 30) swung to the left of the Figure, and the blade 40 reinserted under the window (W), for pulling or pushing the device 1 from the left of FIG. 5.

FIG. 2b illustrates an embodiment in which the Y-handle 130 that includes a top portion 131 that has a curved or “concave”, rather than angular, interior surface 135, forming interior space 137. In a manner similar to the angular top portion 31, this generally semi-cylindrical interior surface 135 contacts hand grip 21 and receives the hand grip 21 in interios space 137.

The invention has many advantages over the current state of the art. The combination of the T-handle and Y-handle allow the user greater control over the pitch of the blade and rotation or twisting of the cold knife handle while reducing the strain caused by the natural tendency of the cold knife handle to twist. It also allows the user to pull with both hands producing greater cutting force with less exertion and muscle fatigue. The invention functions whether the knife is pulled towards the user or pushed away—unlike present cold knives, which must be pulled towards the user. The invention also be used with one or two hands. Gripping only the combined T-handle and Y-handle also extends the reach of the user.

Although this invention has been described above with reference to particular means, materials, and embodiments, it is to be understood that the invention is not limited to these disclosed particulars, but extends instead to all equivalents within the scope of the following claims.

I claim:

1. In a cold knife having a main handle having a bottom end and a top end, and having a blade extending from the bottom end and an optional first pull handle attached at or near the bottom end, which first pull handle may by rigid or flexible, the combination of said cold knife with:
an elongated second pull handle made of a rigid material connected to and extending from the main handle at or near the top end of said main handle.

2. A combination according to claim 1, where said second pull handle is sized and shaped so as to cooperate with said first pull handle such that both pull handles may be gripped and pulled together.

3. A combination according to claim 1 wherein said second pull handle can be moved to either side of said standard cold knife in the plane of the knife's cutting direction.

4. A combination according to claim 1 wherein said second pull handle can pivot parallel to said main handle extending above said [standard] cold knife.

5. A combination according to claim 1 where said second pull handle comprises a stiff arm and one or more extensions from the arm, which extensions are “V” shaped as viewed looking at an end of the extension(s) so that the extensions have an interior surface.

6. A combination according to claim 1 where the interior surface of said V-shaped grip(s) face toward said main handle.

7. A combination according to claim 1 where the interior surface of said V-shaped grip(s) face away from said main handle.

8. A cold knife according to claim 1 where said second pull handle comprises a stiff arm and one or more extensions from the arm, which extensions are curve-shaped as viewed looking at the end of the extension(s).

9. A cold knife according to claim 8 where concave side of said curved grips face toward said main handle.

10. A cold knife according to claim 8 where concave side of said curved grips face away from said main handle.
